(19) United States
(12) Patent Application Publication
(10) Pub. No.: US 2026/0281297 A1
(43) Pub. Date: Sep. 17, 2026

(54) INFORMATION PROCESSING METHOD AND NON-TRANSITORY COMPUTER READABLE MEDIUM

(71) Applicant: FUJIFILM Business Innovation Corp., Tokyo (JP)

(72) Inventors: Kiyofumi AIKAWA, Kanagawa (JP); Yoshitaka KUWADA, Kanagawa (JP); Kazuya FUKUNAGA, Kanagawa (JP); Kaito TASAKI, Kanagawa (JP); Kiyoshi IIda, Kanagawa (JP)

(73) Assignee: FUJIFILM Business Innovation Corp., Tokyo (JP)

(21) Appl. No.: 19/302,589

(22) Filed: Aug. 18, 2025

(30) Foreign Application Priority Data
Mar. 13, 2025 (JP) 2025-039876

(51) Int. Cl. H04N 13/221; H04N 13/254; H04N 13/275

(52) U.S. Cl. CPC H04N 13/221; H04N 13/254; H04N 13/275

(57) ABSTRACT

An information processing method includes, by a processor, when determining a unit rotation angle in a case where at least one of a capturing device including a camera and a surface light source and an existing object is rotationally moved around a preset rotation axis and a surface of the object is captured from a plurality of directions, setting positional coordinates corresponding to the rotation axis, the camera, the surface light source, and a three-dimensional model of the object in a simulation space, receiving designation of a micro region on the three-dimensional model of the object, calculating, as a first rotation angle with respect to the rotation axis, a positional relationship in which a first illumination light output from a first end point among illumination lights output from the surface light source is specularly reflected by the micro region and is incident on the camera, calculating, as a second rotation angle with respect to the rotation axis, a positional relationship in which a second illumination light output from a second end point among illumination lights output from the surface light source is specularly reflected by the micro region and is incident on the camera, and determining that a difference between the calculated first rotation angle and the calculated second rotation angle is the unit rotation angle.

### CROSS-REFERENCE TO RELATED APPLICATIONS

This application is based on and claims priority under 35 USC 119 from Japanese Patent Application No. 2025-039876 filed Mar. 13, 2025.

### BACKGROUND

### (i) Technical Field

The present disclosure relates to an information processing method and a non-transitory computer readable medium.

### (ii) Related Art

There is a technique for reproducing a three-dimensional model of an existing object on a computer. With this type of technique, a method is employed in which a texture that reproduces specular reflection components of the object is attached to the three-dimensional model of the object.

Examples of the related art include Japanese Unexamined Patent Application Publication No. 2003-216970.

### SUMMARY

However, the method for calculating a difference between direction angles when the existing object is captured from a plurality of directions in accordance with the shape of the object is not known. Therefore, for a certain object, the number of captured images is larger than the ideal number of images, and the time required for image processing and capturing is longer than the ideal time. Furthermore, for a certain object, the number of captured images is less than the ideal number of images, and there is a part where the texture or the like is not reproduced.

Aspects of non-limiting embodiments of the present disclosure relate to obtaining an optimal difference between direction angles for generating a three-dimensional model that reproduces the texture and glossy appearance of an object, as compared to a case where a fixed difference between the direction angles used to capture a real object is given.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing method including: by a processor, when determining a unit rotation angle in a case where at least one of a capturing device including a camera and a surface light source and an existing object is rotationally moved around a preset rotation axis and a surface of the object is captured from a plurality of directions, setting positional coordinates corresponding to the rotation axis, the camera, the surface light source, and a three-dimensional model of the object in a simulation space; receiving designation of a micro region on the three-dimensional model of the object; calculating, as a first rotation angle with respect to the rotation axis, a positional relationship in which a first illumination light output from a first end point among illumination lights output from the surface light source is specularly reflected by the micro region and is incident on the camera; calculating, as a second rotation angle with respect to the rotation axis, a positional relationship in which a second illumination light output from a second end point among illumination lights output from the surface light source is specularly reflected by the micro region and is incident on the camera; and determining that a difference between the calculated first rotation angle and the calculated second rotation angle is the unit rotation angle.

### BRIEF DESCRIPTION OF THE DRAWINGS

Exemplary embodiments of the present invention will be described in detail based on the following figures, wherein:

FIG. 1 is a diagram illustrating a schematic configuration of a gloss reading system assumed according to a first exemplary embodiment;

FIG. 2 is a diagram illustrating a functional configuration of the gloss reading system;

FIG. 3 is a diagram illustrating an example of a hardware configuration of a simulation apparatus;

FIG. 4 is a flowchart illustrating an operation based on a principle of determining the unit rotation angle;

FIG. 5 is a plan view illustrating an observation environment in a simulation space;

FIG. 6 is a diagram illustrating a surface normal angle;

FIG. 7 is a diagram illustrating the surface normal angle at a point farthest from a rotation center;

FIG. 8 is a diagram illustrating a rotation angle at which an incident angle and a reflection angle are the same;

FIG. 9 is a diagram illustrating a relationship among the surface normal angle, the unit rotation angle, and a distance;

FIG. 10 is a diagram schematically illustrating an angle range;

FIG. 11 is a flowchart illustrating an operation of determining a unit rotation angle focusing on a micro region that provides a maximum outer diameter;

FIG. 12 is a flowchart illustrating an example of processing to generate a three-dimensional model including gloss information;

FIG. 13 is a flowchart illustrating another example of processing to generate a three-dimensional model including gloss information; and

FIG. 14 is a diagram illustrating a schematic configuration of another gloss reading system.

### DETAILED DESCRIPTION

Exemplary embodiments of the invention will be described below with reference to the drawings.

### First Exemplary Embodiment

### <System Configuration>

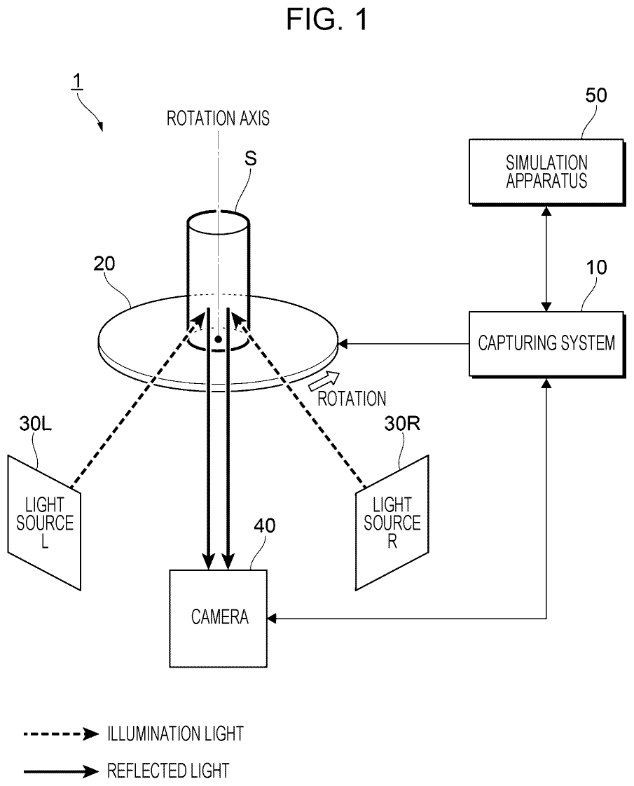

FIG. 1 is a diagram illustrating a schematic configuration of a gloss reading system 1 assumed according to a first exemplary embodiment. The gloss reading system 1 illustrated in FIG. 1 includes a capturing system 10, a rotating table 20, light sources 30R and 30L, a camera 40, and a simulation apparatus 50.

The light sources 30R and 30L and the camera 40 are examples of a capturing device.

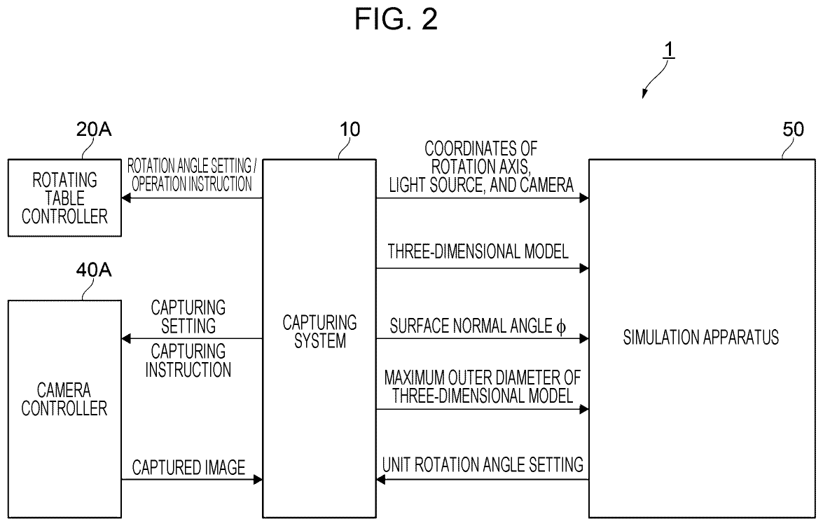

The capturing system 10 is a computer that controls the rotating table 20, the light sources 30R and 30L, and the camera 40, and controls the capturing of a three-dimensional object S. The capturing system 10 controls the rotation of the rotating table 20 by controlling a rotating table controller 20A (see FIG. 2). The capturing system 10 controls the light sources 30R and 30L to be turned on or off, etc. The capturing system 10 controls the capturing of the three-dimensional object S by the camera 40.

The three-dimensional object S can be detachably attached to the rotating table 20. The three-dimensional object S may be any object from which gloss information is to be read. The three-dimensional object S is an object existing in the real space.

The three-dimensional object S illustrated in FIG. 1 has an elliptic cylindrical shape. The elliptic cylindrical shape is merely an example, and any three-dimensional shape may be used.

The rotating table 20 includes, for example, a disk-shaped seat, a motor (not illustrated) that rotates the seat, and the rotating table controller 20A (see FIG. 2) that controls the rotation of a motor. In FIG. 1, the rotation axis of the rotating table 20 is indicated by a dashed-dotted line.

The rotating table 20 is rotatable around a rotation axis by 360°. FIG. 1 illustrates an example in which the rotating table 20 is rotated counterclockwise. The rotation direction of the rotating table 20 may be clockwise.

The light sources 30R and 30L are surface light sources that illuminate the three-dimensional object S. The light sources 30R and 30L may be collimated light sources or non-collimated light sources (i.e. diffuse light sources). The light source 30R is an example of a first surface light source, and the light source 30L is an example of a second surface light source.

In the case of FIG. 1, the light sources 30R and 30L are arranged at symmetrical positions with respect to a plane including the rotation axis of the rotating table 20 and the capturing optical axis of the camera 40. Since the positions are symmetrical, the tilt angles of the light sources 30R and 30L are also symmetrical.

In other words, the light sources 30R and 30L are arranged on both sides of the half line connecting the rotating table 20 and the camera 40. According to the present exemplary embodiment, the half line is parallel to the capturing optical axis.

In FIG. 1, when viewed from the camera 40 toward the rotating table 20, the light source on the right side is referred to as the light source 30R, and the light source on the left side is referred to as the light source 30L.

The light sources 30R and 30L are arranged in consideration of the size of the three-dimensional object S. To be specific, the light sources 30R and 30L are spaced apart from the rotation axis by such a distance that changes in the incident angle of light incident on a micro region of the three-dimensional object S rotated by the rotating table 20 are ignorable.

The camera 40 is a device that captures a surface of the three-dimensional object S attached to the rotating table 20. As the image sensor of the camera 40, for example, a complementary metal-oxide semiconductor (CMOS) sensor is used. In the case of FIG. 1, the capturing optical axis of the camera 40 is adjusted to intersect with the rotation axis of the rotating table 20. A camera controller 40A (see FIG. 2) controls capturing of still images and the like by the camera 40.

In the case of FIG. 1, the number of cameras 40 is one. A camera that captures the three-dimensional object S from the upper surface side or a camera that captures the three-dimensional object S from the lower surface side may be added.

The simulation apparatus 50 is a computer that reproduces the capturing environment of the three-dimensional object S in a simulation space in cooperation with the capturing system 10.

The simulation apparatus 50 is a computer that determines the rotation angle (hereinafter referred to as “unit rotation angle”) of the rotating table 20 with which specular reflection components from the three-dimensional object S can be captured over the entire circumference of the three-dimensional object S. In the case according to the present exemplary embodiment, the unit rotation angle is given as the angle with which the rotating table 20 rotates between the capturing of the three-dimensional object S by the camera 40 and the subsequent capturing. The simulation apparatus 50 is an example of an information processing system.

### <Functional Configuration>

FIG. 2 is a diagram illustrating a functional configuration of the gloss reading system 1. In FIG. 2, the parts corresponding to those in FIG. 1 are denoted by the corresponding reference numerals.

The capturing system 10 has a function of providing rotation angle setting information and an operation instruction to the rotating table controller 20A. The rotation angle setting information is, for example, a unit rotation angle. The operation instruction is an instruction for rotation by a set rotation angle. When the capturing of the three-dimensional object S ends, the capturing system 10 outputs the subsequent rotation to the rotating table controller 20A.

The capturing system 10 also has a function of giving capturing setting information and a capturing instruction to the camera controller 40A. The capturing setting information is, for example, information for setting a resolution and an angle of view. The capturing instruction is, for example, an instruction to capture a still image. When the rotating table 20 rotates by the unit rotation angle around the rotation axis, for example, the capturing system 10 outputs a capturing instruction to the camera controller 40A.

In addition, the capturing system 10 also has a function of receiving an image captured by the camera 40 (see FIG. 1) from the camera controller 40A.

The capturing system 10 has a function of providing the simulation apparatus 50 with the coordinates of the rotation axis (i.e., the rotation center), the light sources 30R and 30L, and the camera 40. With these coordinates, the capturing environment of the real space is reproduced in the simulation space.

The capturing system 10 also has a function of providing the simulation apparatus 50 with a three-dimensional model to be used for simulation. The three-dimensional model here may be a model generated from the three-dimensional object S (see FIG. 1) or may be an independently selected model.

The capturing system 10 has a function of providing a surface normal angle φ to the simulation apparatus 50. The surface normal angle φ is an angle formed between the normal to a tangent plane of a micro region of the three-dimensional model and a line segment extending from the rotation axis (rotation center) of the rotating table 20 in the direction of the micro region. The surface normal angle φ is given from −90° to +90°, for example. When the simulation apparatus 50 calculates the surface normal angle φ from a given three-dimensional model, the capturing system 10 may use the calculated value of the surface normal angle φ without providing the surface normal angle φ to the simulation apparatus 50.

The capturing system 10 has a function of providing the simulation apparatus 50 with the maximum outer diameter of the three-dimensional model. The maximum outer diameter refers to the greatest distance from the rotation center in which the surface of the three-dimensional model passes while the rotating table 20 rotates by 360°. When the simulation apparatus 50 calculates the maximum outer diameter from a given three-dimensional model, the capturing system 10 may use the calculated value of the maximum outer diameter without giving the maximum outer diameter to the simulation apparatus 50.

The simulation apparatus 50 has a function of determining, based on given information, a unit rotation angle of the rotating table 20 with which specular reflection components can be captured from the entire circumferential surface of the three-dimensional model. The determined unit rotation angle is given from the simulation apparatus 50 to the capturing system 10 as unit rotation angle setting information.

### <Hardware Configuration>

### <Simulation Apparatus>

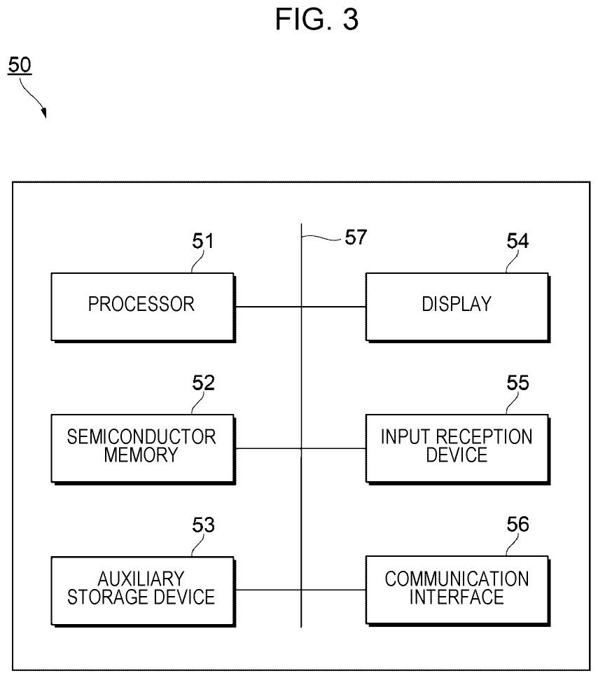

FIG. 3 is a diagram illustrating an example of a hardware configuration of the simulation apparatus 50.

The simulation apparatus 50 illustrated in FIG. 3 includes a processor 51, a semiconductor memory 52, an auxiliary storage device 53, a display 54, an input reception device 55, and a communication interface 56. The devices are connected to one another via a signal line 57 such as a bus.

The processor 51 is a device that performs various functions through execution of programs.

The semiconductor memory 52 may include, for example, a read only memory (ROM) in which a unified extensible firmware interface (UEFI) or the like is stored and a random access memory (RAM) used as a work area of the processor 51.

The processor 51 and the semiconductor memory 52 function as what is called a computer.

The auxiliary storage device 53 includes, for example, a hard disk device or a semiconductor storage. The auxiliary storage device 53 stores programs and various types of data. The term “program” is used as a generic term for an operating system (OS) and application programs. The auxiliary storage device 53 stores, as one of the programs, a program for determining the unit rotation angle by simulation.

Simulation results and the like are displayed on the display 54. As the display 54, for example, a liquid crystal display or an organic electroluminescence (EL) display is used.

The input reception device 55 is a device that receives an input operation from an input device such as a mouse, a keyboard, or a button.

The communication interface 56 is an interface for communicating with the capturing system 10 (see FIG. 2) via the network N. The communication interface 56 complies with various communication standards. Examples of the communication standard include Ethernet (registered trademark), Wi-Fi (registered trademark), and a mobile communication system.

### <Capturing System>

The hardware configuration of the capturing system 10, which is a computer, is essentially the same as that of the simulation apparatus 50. In the case according to the present exemplary embodiment, the capturing system 10 is not provided with a display or an input reception device.

### <Principle of Determining Unit Rotation Angle>

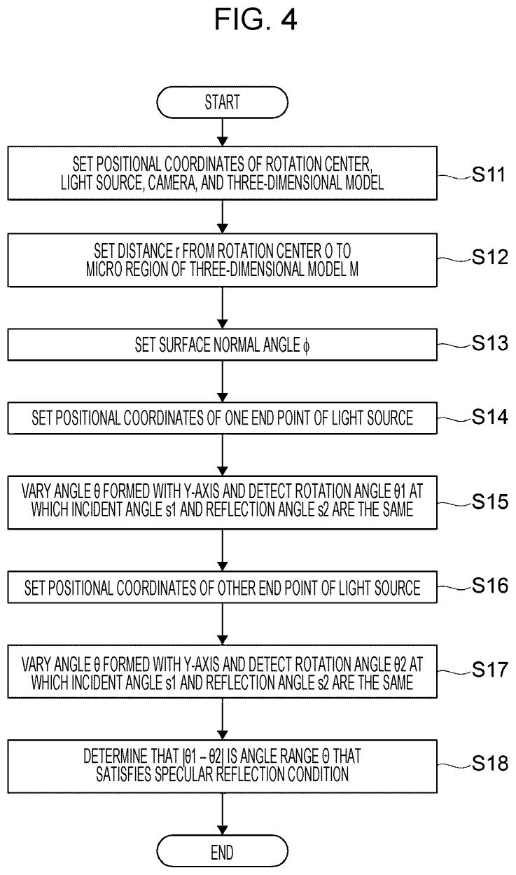

FIG. 4 is a flowchart illustrating an operation based on a principle of determining the unit rotation angle. The symbol S illustrated in the drawings refers to a step.

The processing operation illustrated in FIG. 4 is implemented by the processor 51 (see FIG. 3) through execution of a program.

For the sake of simplicity, the principle of determining the unit rotation angle with which gloss can be read from the entire circumference of the three-dimensional model on a two-dimensional plane obtained by cutting the three-dimensional model M at a certain height will be described below.

However, when a camera that captures the three-dimensional object S from the upper surface side or a camera that captures the three-dimensional object S from the lower surface side is provided, the unit rotation angle described below is determined for each combination of each camera and the light source.

First, the processor 51 sets the positional coordinates of a rotation center O, the light sources 30R and 30L (see FIG. 1), the camera 40 (see FIG. 1), and the three-dimensional model M (step S11). The positional coordinates are given as coordinate points in the simulation space.

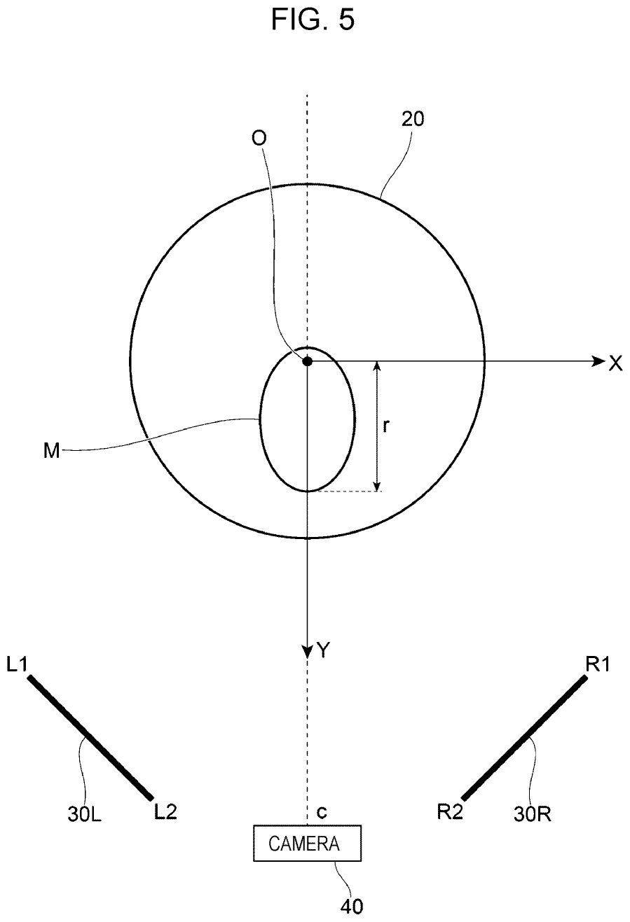

Subsequently, the processor 51 sets a distance r from the rotation center O to a micro region of the three-dimensional model M (see FIG. 5) (step S12). The micro region is a region of a side surface (or a front surface) of the three-dimensional model M.

FIG. 5 is a plan view illustrating an observation environment in the simulation space.

FIG. 5 illustrates the rotation center O of the rotating table 20. The three-dimensional model M rotated around the rotation center O as a central axis has an elliptic cylindrical shape. As the three-dimensional model M illustrated in FIG. 5 is a cross-sectional view at a certain height, the three-dimensional model M is represented as an ellipse. FIG. 5 also illustrates a center c of an opening of the camera 40.

In FIG. 5, the direction passing through the rotation center O and the center c of the opening is defined as a Y-axis, and one direction orthogonal to the Y-axis on a plane is defined as an X-axis. The rotation center O coincides with the origin of the X-axis and the Y-axis.

The long axis of the three-dimensional model M illustrated in FIG. 5 is parallel to the Y axis, and the short axis thereof is parallel to the X axis.

The coordinates of the micro region of the three-dimensional model M, a left end point R2 of the light source 30R, a right end point R1 of the light source 30R, a left end point L1 of the light source 30L, a right end point L2 of the light source 30L, and the center c of the opening of the camera 40 are also given as coordinate values on the two-dimensional plane defined by the X-axis and the Y-axis.

The right end point R1 of the light source 30R and the left end point L1 of the light source 30L are end portions farther from the camera 40. The right end point R1 and the left end point L1 are examples of a first end point.

The left end point R2 of the light source 30R and the right end point L2 of the light source 30L are end portions closer to the camera 40. The left end point R2 and the right end point L2 are examples of a second end point.

A reference is made back to the description of FIG. 4.

The processor 51 sets the surface normal angle φ (step S13). In the case according to the present exemplary embodiment, the surface normal angle φ is given from −90° to +90°.

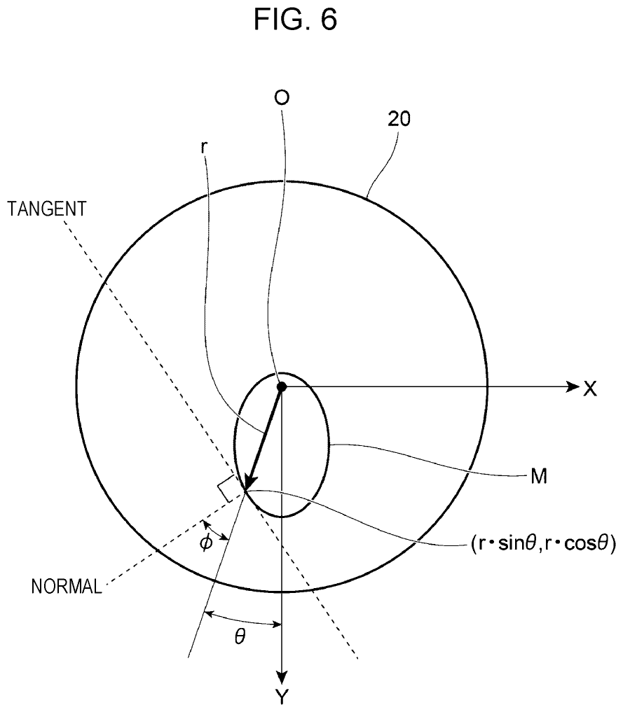

FIG. 6 is a diagram illustrating the surface normal angle φ.

In FIG. 6, both the tangent to the micro region (the region represented by a vector from the rotation center O of the rotating table 20) on the surface of the three-dimensional model M and the normal including the tangent are represented in broken lines.

The arrow extending from the rotation center O of the rotating table 20 toward the micro region is indicated in a solid line. The surface normal angle φ is given as the angle formed between the normal and the line segment.

According to the present exemplary embodiment, a rotation angle θ of the rotating table 20 is given as the angle formed with the Y-axis. In this case, the coordinates of the micro region of the three-dimensional model M are given by (r·sin θ, r·cos θ).

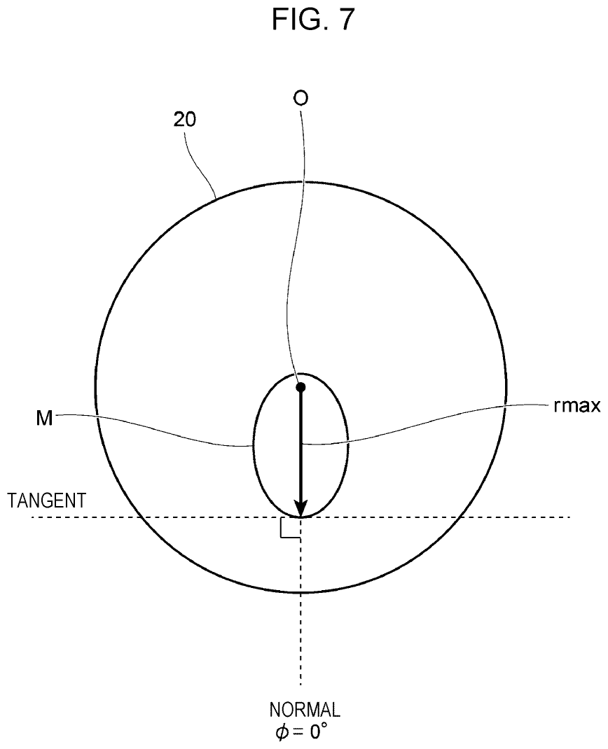

FIG. 7 is a diagram illustrating the surface normal angle φ at a point (distance rmax) farthest from the rotation center O. In FIG. 7, the parts corresponding to those in FIG. 6 are denoted by the corresponding reference numerals.

As illustrated in FIG. 7, the direction of the normal including the tangent to the micro region and the arrow extending from the rotation center O toward the micro region are located on the same line. Therefore, the surface normal angle φ is 0°.

The reason why the surface normal angle φ is taken into consideration is that the reflection directions of the incident lights from the light sources 30R and 30L depend on the surface normal angle φ.

A reference is made back to the description of FIG. 4.

When the process in step S13 ends, the processor 51 sets the positional coordinates of one end point of the surface light source (step S14).

As described above, according to the present exemplary embodiment, the light sources 30R and 30L are arranged at symmetrical positions with respect to the plane including the rotation axis of the rotating table 20 and the capturing optical axis of the camera 40. When the two light sources 30R and 30L are arranged at symmetrical positions, the unit rotation angle determined for the light source 30R and the camera 40 is the same as the unit rotation angle determined for the light source 30L and the camera 40.

For this reason, only the light source 30R will be described below. In step S14, for example, the positional coordinates of the end point R1 of the light source 30R are set.

Subsequently, the processor 51 varies the angle θ formed with the Y-axis and detects a rotation angle θ1 at which an incident angle s1 and a reflection angle s2 are the same (step S15).

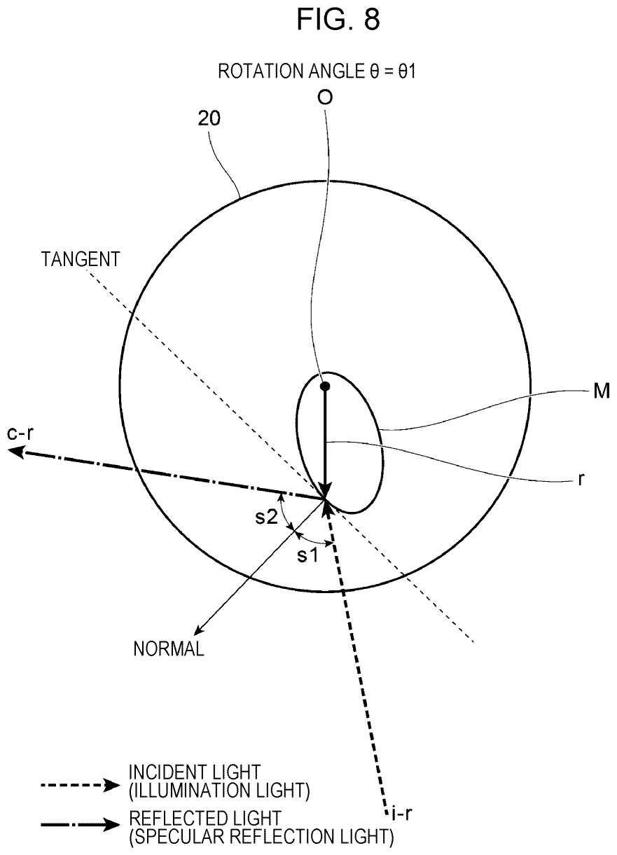

FIG. 8 is a diagram illustrating the rotation angle θ1 at which the incident angle s1 and the reflection angle s2 are the same. FIG. 8 illustrates the relationship between the incident angle s1 and the reflection angle s2 in the micro region specified by the angle θ1 formed with the Y-axis.

In the case according to the present exemplary embodiment, the rotation angle θ1 is obtained, at which the specular reflection light enters the camera 40 (see FIG. 1).

In the case of FIG. 8, the vector that gives the incident light (i.e., illumination light) is represented as a difference i−r between a vector i that gives the positional coordinates of the end point and a vector r that gives the positional coordinates of the micro region. On the other hand, the vector that gives the reflected light (i.e., specular reflection light) is represented as a difference c−r between a vector c that gives the positional coordinates of the center c of the opening of the camera 40 and a vector r that gives the positional coordinates of the micro region.

The incident angle s1 from the end point set in step S14 is given by the following equation.

$$s 1 ( r , φ , θ ) = arg ( i - r , r )$$

On the other hand, the reflection angle s2 is given by the following equation.

$$s 2 ( r , φ , θ ) = arg ( c - r , r )$$

Here, s1=s2 means that the specularly reflected illumination light is incident on the center c of the opening of the camera 40.

The rotation angle θ1 that satisfies s1=s2 is represented by the function (that is, θ1=(r, φ)) of the distance r to the micro region of the three-dimensional model M and the surface normal angle φ. When the distance r to the micro region of the three-dimensional model M is a constant, the rotation angle θ1 is represented by the function θ1(φ) having the surface normal angle φ as a variable.

The rotation angle θ1(r, φ) detected in step S15 is denoted by θ1.

A reference is made back to the description of FIG. 4.

Similarly, the processor 51 sets the positional coordinates of the other end point of the light source (step S16). In step S16, for example, the positional coordinates of the end point R2 of the light source 30R are set.

Subsequently, the processor 51 varies the angle θ formed with the Y-axis, for example, and detects a rotation angle θ2 at which the incident angle s1 and the reflection angle s2 are the same (step S17). The rotation angle θ2 here may also be referred to as the rotation angle θ2(r, φ).

The processing operations in steps S16 and S17 are the same as those in steps S14 and S15.

Through the processes in steps S14 to S17, the rotation angle θ1 at which the specular reflection light corresponding to the end point R1 of the light source 30R is incident on the camera 40 and the rotation angle θ2 at which the specular reflection light corresponding to the end point R2 of the light source 30R is incident on the camera 40 are detected.

Then, the processor 51 determines that |θ1−θ2|(=Δθ) is an angle range Θ that satisfies the specular reflection condition (step S18). The angle range Θ provides the range of the micro region where all the specular reflection lights corresponding to the light source 30R are incident on the camera 40.

As described above, both the rotation angles θ1 and θ2 are given by the function θ(r, φ) of the distance r and the surface normal angle φ.

Therefore, the angle range θ=|θ1−θ2| (that is, Δθ) can also be represented by the function Δθ(r, φ) of the distance r and the surface normal angle φ.

According to the present exemplary embodiment, the angle range Θ is determined to be the unit rotation angle. Therefore, the unit rotation angle is also referred to as Δθ(r, φ) or Δθ(φ).

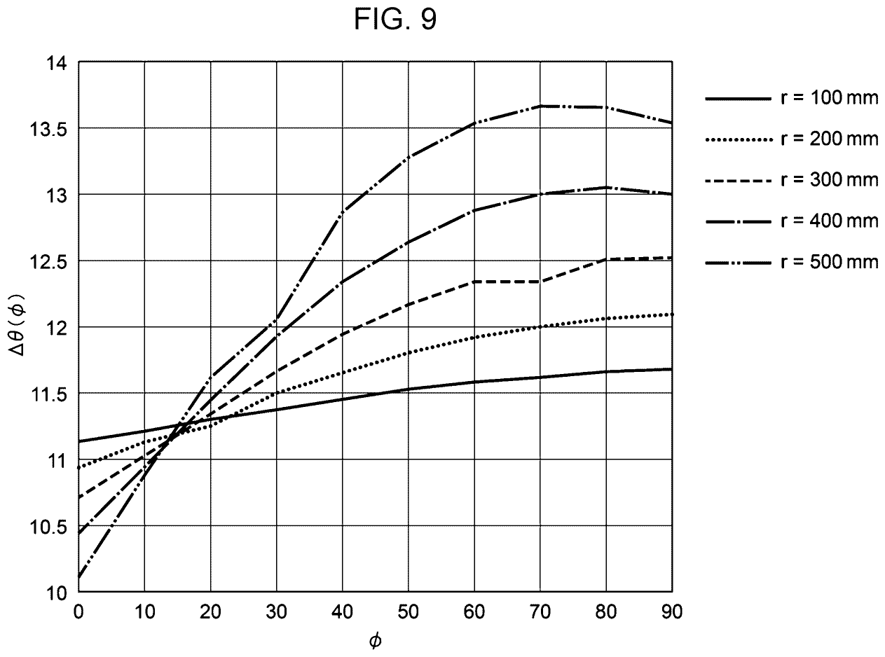

FIG. 9 is a diagram illustrating the relationship among the surface normal angle φ, the unit rotation angle Δθ(φ), and the distance r. The vertical axis represents Δθ(φ), and the horizontal axis represents the surface normal angle φ.

FIG. 9 is a graph illustrating changes in the unit rotation angle Δθ(φ) when the distances r are 100 mm, 200 mm, 300 mm, 400 mm, and 500 mm.

It can be seen from FIG. 9 that, regardless of the distance r, the smaller the surface normal angle φ, the smaller the unit rotation angle Δθ(φ). That is, the smaller the surface normal angle φ, the smaller the angle range Θ in which the specular reflection image of the object surface is captured with a given light source.

Therefore, in order to acquire a specular reflection image of the three-dimensional model M at the constant distance r from the rotation center O, the unit rotation angle Δθ(r, 0°) may be determined in consideration of the case where the surface normal angle φ is 0°. In this case, the unit rotation angle Δθ(r, 0°) at which a specular reflection image can be captured can be determined regardless of the distance r.

That is, in step S13 (see FIG. 4), the surface normal angle φ may be set to 0°.

From the graph illustrated in FIG. 9, the following relationship is also understood. In a case where the surface normal angle φ=0°, as the distance r from the rotation center O increases (for example, 500 mm), the angle range Θ (i.e., Δθ) decreases, in which the specular reflection image is captured. That is, even in a case where the surface normal angle φ is the same, as the distance r from the rotation center O increases, the angle range Θ (i.e., Δθ) decreases, in which the specular reflection image of the object surface can be captured with a given light source. In other words, this means that the range of the micro region where the specular reflection is captured is narrowed.

Therefore, when the three-dimensional model M is attached to the rotating table 20 (see FIG. 1) in step S12 (see FIG. 4), the unit rotation angle may be determined by setting the longest distance r from the rotation center O.

Therefore, the processor 51 determines that the angle range Θ for the micro region with the maximum outer diameter rmax (see FIG. 7) of the three-dimensional model M when the surface normal angle φ=0° is the unit rotation angle (i.e., the angle range Θ).

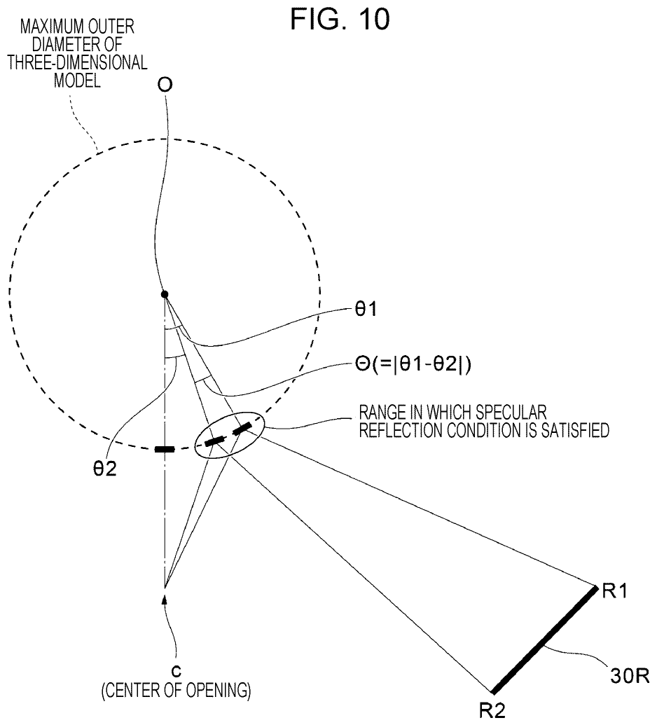

FIG. 10 is a diagram schematically illustrating the angle range Θ. In FIG. 10, the parts corresponding to those in FIG. 5 are denoted by the corresponding reference numerals. In FIG. 10, only the light source 30R is illustrated, and the description of the light source 30L is omitted.

This is because, in the case according to the present exemplary embodiment, the light source 30R and the light source 30L are arranged symmetrically with respect to the plane including the rotation axis and the center c of the opening of the camera 40, and the angle range Θ of the light source 30R and the angle range Θ of the light source 30L are the same.

However, when the light source 30R and the light source 30L are not arranged symmetrically with respect to the plane including the rotation axis and the center c of the opening of the camera 40, the angle range Θ of the light source 30L is determined in the same manner. Then, it is determined that the smaller one of the angle range Θ for the light source 30R and the angle range Θ for the light source 30L is the unit rotation angle.

By determining that the smaller angle range Θ is the unit rotation angle, it is possible to capture the specular reflection light regardless of the unevenness or the inclination direction of the surface of the three-dimensional model.

<Determination of Unit Rotation Angle to which Determination Principle is Applied>

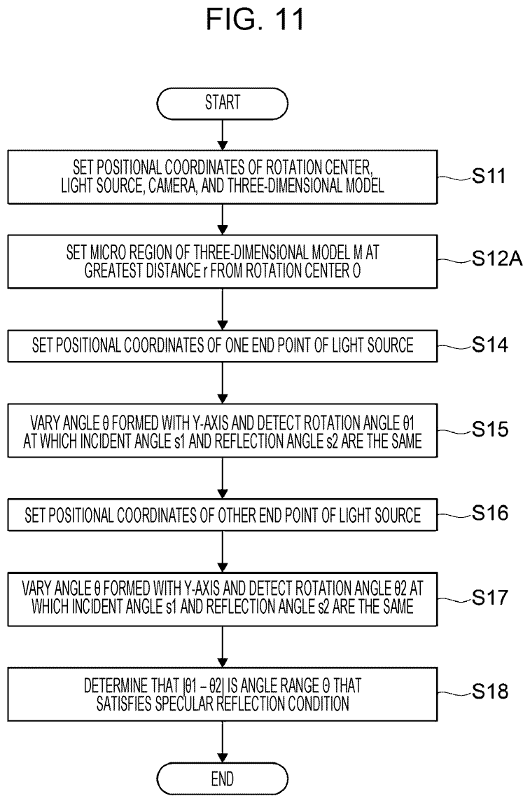

FIG. 11 is a flowchart illustrating an operation of determining a unit rotation angle focusing on a micro region that provides a maximum outer diameter. In FIG. 11, the parts corresponding to those in FIG. 4 are denoted by the corresponding reference numerals.

Also, in the case of FIG. 11, first, the processor 51 sets the positional coordinates of the rotation center O, the light sources 30R and 30L (see FIG. 1), the camera 40 (see FIG. 1), and the three-dimensional model M (step S11).

Subsequently, the processor 51 sets a micro region of the three-dimensional model M at the greatest distance r from the rotation center O (step S12A).

Then, the processor 51 executes steps S14 to S18 for the micro region set in step S12A to determine the unit rotation angle.

### <Process for Generating Three-Dimensional Model Including Gloss Information>

### <Generation Processing 1>

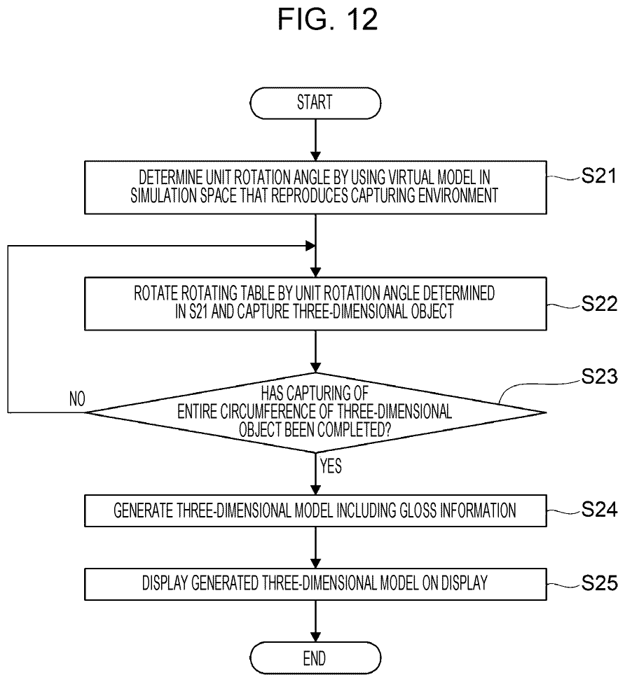

FIG. 12 is a flowchart illustrating an example of processing to generate a three-dimensional model including gloss information. The generation processing illustrated in FIG. 12 is executed by the capturing system 10 (see FIG. 1) in cooperation with the simulation apparatus 50 (see FIG. 1).

First, the simulation apparatus 50 determines the unit rotation angle by using a virtual model in the simulation space that reproduces the capturing environment (step S21). The virtual model may be selected based on the three-dimensional object S (see FIG. 1) that is likely to be captured in the real space, or a general-purpose model may be used. The virtual model is a three-dimensional model.

When the light sources are arranged at multiple heights, for example, when the light sources are also arranged obliquely above or below the virtual model, the angle range Θ is determined for all the light source positions, and the minimum value is set as the unit rotation angle.

The unit rotation angle may be less than or equal to the unit rotation angle determined in step S18 (see FIG. 11).

Subsequently, the capturing system 10 rotates the rotating table 20 (see FIG. 1) by the unit rotation angle determined in step S21 and captures the three-dimensional object S (step S22). As described above, when the unit rotation angle is determined based on the maximum outer diameter rmax, the camera 40 can capture the specular reflection light on the surface of the three-dimensional object S of any shape.

Subsequently, the capturing system 10 determines whether the capturing of the entire circumference of the three-dimensional object S has been completed (step S23). That is, it is determined whether the total value of the rotation angles of the rotating table 20 exceeds 360°.

When the capturing of the entire circumference of the three-dimensional object S has not been completed, a negative result is obtained in step S23. In this case, the capturing system 10 returns to step S22.

When the capturing of the entire circumference of the three-dimensional object S has been completed, a positive result is obtained in step S23. In this case, the capturing system 10 provides the captured image to the simulation apparatus 50 and generates a three-dimensional model including the gloss information (step S24). The gloss information also includes color information.

For example, the capturing system 10 maps the image including the gloss information captured in step S22 onto the surface of the three-dimensional model of the three-dimensional object S and generates the three-dimensional image including the gloss information. The three-dimensional model of the three-dimensional object S is, for example, generated in advance and stored in the auxiliary storage device 53 (see FIG. 3) or the like.

Then, the simulation apparatus 50 displays the generated three-dimensional model on the display 54 (see FIG. 3) (step S25).

### <Generation Processing 2>

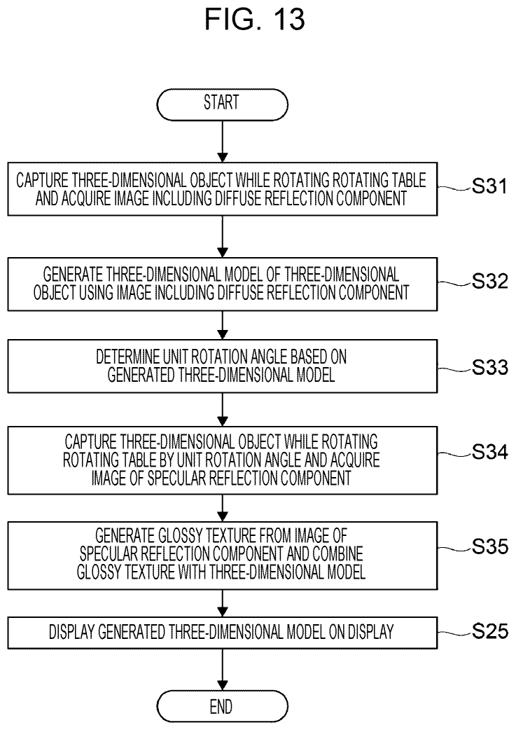

FIG. 13 is a flowchart illustrating another example of processing to generate a three-dimensional model including gloss information. In FIG. 13, the parts corresponding to those in FIG. 12 are denoted by the corresponding reference numerals.

The generation processing illustrated in FIG. 13 is executed by the capturing system 10 (see FIG. 1) in cooperation with the simulation apparatus 50 (see FIG. 1).

First, the capturing system 10 captures the three-dimensional object S while rotating the rotating table 20 (see FIG. 1) and acquires the image including a diffuse reflection component (step S31). The image also includes a color component. The acquired image is provided to the simulation apparatus 50.

The simulation apparatus 50 generates a three-dimensional model of the three-dimensional object S using the image including the diffuse reflection component in the simulation space (step S32).

Subsequently, the simulation apparatus 50 determines the unit rotation angle based on the generated three-dimensional model (step S33). When the unit rotation angle is generated, the coordinates of the rotation center of the rotating table 20, the coordinates of the light sources 30R and 30L, the coordinates of the center c of the opening of the camera 40, and the like, are provided from the capturing system 10 to the simulation apparatus 50.

In the case of the generation processing 2, the unit rotation angle optimized for the three-dimensional object S to be captured is determined. The determined unit rotation angle is provided from the simulation apparatus 50 to the capturing system 10.

Then, the capturing system 10 captures the three-dimensional object S while rotating the rotating table by each unit rotation angle and acquires the image of the specular reflection component (step S34). The acquired image is provided from the capturing system 10 to the simulation apparatus 50.

Subsequently, the simulation apparatus 50 generates a glossy texture from the image of the specular reflection component and combines the glossy texture with the three-dimensional model (step S35).

Then, the simulation apparatus 50 displays the generated three-dimensional model on the display 54 (see FIG. 3) (step S25).

### SUMMARY

As the unit rotation angle of the rotating table 20 is determined by the above-described method, the three-dimensional model that reproduces the texture and glossy appearance of the three-dimensional object can be generated with the minimum number of times capturing is executed.

### OTHER EXEMPLARY EMBODIMENTS

(1) Although the exemplary embodiment of the invention has been described above, the technical scope of the present disclosure is not limited to the scope described in the embodiment above. It is apparent from the scope of claims that various changes and improvements to the above-described embodiment are also included in the technical scope of the present disclosure.

(2) In the case described according to the above exemplary embodiment, the three-dimensional object S to be captured is attached to the rotating table 20 (see FIG. 1), and the light sources 30R and 30L (see FIG. 1) and the camera 40 (see FIG. 1) are provided around the rotating table 20.

However, the three-dimensional object S to be captured may be provided at the rotation center O, and the light sources 30R and 30L (see FIG. 1) and the camera 40 (see FIG. 1) may be relatively rotated and moved.

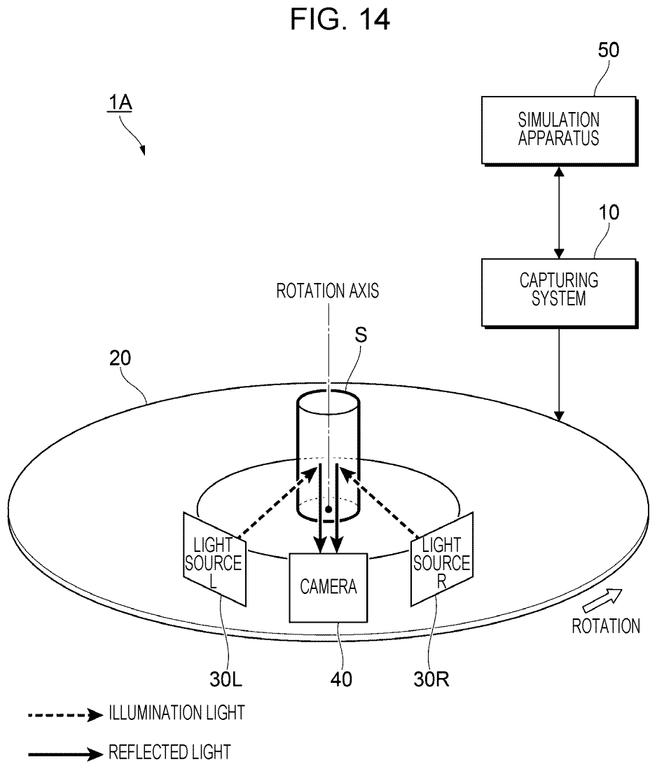

FIG. 14 is a diagram illustrating a schematic configuration of another gloss reading system 1A. In FIG. 14, the parts corresponding to those in FIG. 1 are denoted by the corresponding reference numerals.

In the case of FIG. 14, the rotating table 20 has a doughnut shape with an opening near the center of the disk. Therefore, the three-dimensional object S is located in the opening provided near the rotation axis of the rotating table 20. In the case of the gloss reading system 1A illustrated in FIG. 14, the camera 40 or the like attached to the rotating table 20 captures the entire circumference of the three-dimensional object S while rotating.

The method for determining the unit rotation angle is the same as that in the first exemplary embodiment described above.

(3) According to the above exemplary embodiment, as in step S22 of FIG. 12 or step S34 of FIG. 13, the three-dimensional object S is captured each time the rotating table 20 is rotated by the unit rotation angle.

However, each time the rotation angle of the rotating table 20 reaches the unit rotation angle from the previous capturing position (i.e., each time it is detected that the unit rotation angle has been reached), an instruction may be given to the camera 40 (see FIG. 1) to capture a still image.

(4) According to the above exemplary embodiment, the camera 40 periodically captures still images of the three-dimensional object S.

However, the camera 40 may capture the rotating three-dimensional object S as a moving image. In this case, the capturing system 10 may capture a still image of the three-dimensional object S at a timing when the three-dimensional object S rotates by the unit rotation angle from the capturing position of the previous still image.

(5) In the above exemplary embodiment, the entire circumference of the three-dimensional object S is to be observed, only a part of the three-dimensional object S may be set as the observation range. In this case, the unit rotation angle may be determined by obtaining the angle range Θ of the micro region having the greatest distance from the rotation center O within the observation range.

(6) In the case described according to the above exemplary embodiment, the capturing system 10 (see FIG. 1) and the simulation apparatus 50 (see FIG. 1) are separate systems.

However, the simulation apparatus 50 may be one of the functions executed by the capturing system 10. That is, the simulation apparatus 50 may be integrated with the capturing system 10.

(7) In the case described above, the gloss reading system 1 (see FIG. 1) and the gloss reading system 1A (see FIG. 14) include the two light sources.

However, each system may include one light source or three or more light sources.

(8) According to the exemplary embodiment described above, each processing is executed by any computer. In addition, any computer may execute each processing by a processor as hardware, a program as software, or a combination thereof.

In this case, the processor is configured to execute various types of processing according to the exemplary embodiments in cooperation with the program and may function as each unit or each means according to the exemplary embodiment.

The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be configured by a programmable logic device such as a central processing unit (CPU), a micro processing unit (MPU), or a field programmable gate array (FPGA), a dedicated circuit for executing specific processing, such as an application specific integrated circuit (ASIC), or hardware such as a graphic processing unit (GPU) or a neural processing unit (NPU).

Regarding the type of the hardware, different types of hardware may be combined. When a plurality of pieces of hardware is configured to execute one or more processes of a certain processor, the plurality of pieces of hardware may exist in devices physically separated from each other, or may exist in the same device. In addition, according to any exemplary embodiment, the order of the processes performed by the processor is not limited to the order described above, and may be appropriately changed. The hardware is composed of electric circuitry in which circuit elements such as semiconductor devices are combined, or the like.

Further, the program may be software such as firmware or microcode. In addition, the program may be, for example, a program module group, and each function thereof may be realized by a processor configured to execute each function. The program may be a program code or a plurality of code segments stored in one or more non-transitory computer-readable media (e.g., storage media or other storage).

The program may be stored in such a divided manner in multiple non-transitory computer readable media present in apparatuses physically away from each other. The program code or the code segments may represent procedures, functions, subprograms, routines, subroutines, modules, software packages, classes, or any combination of instructions, data structures, or program statements. The program code or the code segment may be connected to another code segment or a hardware circuit by transmitting and/or receiving information, data, an argument, a parameter, or memory content.

(9) The present disclosure is also applicable to programs and program products.

### APPENDIX

(((1)))

An information processing method comprising:
by a processor, when determining a unit rotation angle in a case where at least one of a capturing device including a camera and a surface light source and an existing object is rotationally moved around a preset rotation axis and a surface of the object is captured from a plurality of directions,
setting positional coordinates corresponding to the rotation axis, the camera, the surface light source, and a three-dimensional model of the object in a simulation space;
receiving designation of a micro region on the three-dimensional model of the object;
calculating, as a first rotation angle with respect to the rotation axis, a positional relationship in which a first illumination light output from a first end point among illumination lights output from the surface light source is specularly reflected by the micro region and is incident on the camera;
calculating, as a second rotation angle with respect to the rotation axis, a positional relationship in which a second illumination light output from a second end point among illumination lights output from the surface light source is specularly reflected by the micro region and is incident on the camera; and
determining that a difference between the calculated first rotation angle and the calculated second rotation angle is the unit rotation angle.
   (((2)))

The information processing method according to (((1))), wherein
the first end point is an end portion of the surface light source farther from the camera, and
the second end point is an end portion of the surface light source closer to the camera.
   (((3)))

The information processing method according to (((1))) or (((2))), further comprising, by the processor, determining the unit rotation angle for a micro region where a distance from the rotation axis to the surface of the object is the longest.

(((4)))

The information processing method according to any one of (((1))) to (((3))), further comprising, by the processor, determining the unit rotation angle for a micro region where an angle formed between a half line extending from the rotation axis toward the surface of the object and a normal to the surface of the object is 0°.

(((5)))

The information processing method according to any one of (((1))) to (((4))), wherein the surface light source includes a first surface light source and a second surface light source,
the information processing method further comprising arranging the first surface light source and the second surface light source on both sides of a half line connecting the camera and a rotation center.
   (((6)))

The information processing method according to (((5))), further comprising, by the processor, determining that a smaller one of a first unit rotation angle calculated with respect to the rotation axis for the first surface light source and a second unit rotation angle calculated with respect to the rotation axis for the second surface light source is the unit rotation angle.

(((7)))

A program causing a computer to execute a process comprising:
when determining a unit rotation angle in a case where at least one of a capturing device including a camera and a surface light source and an existing object is rotationally moved around a preset rotation axis and a surface of the object is captured from a plurality of directions,
setting positional coordinates corresponding to the rotation axis, the camera, the surface light source, and a three-dimensional model of the object in a simulation space;
receiving designation of a micro region on the three-dimensional model of the object;
calculating, as a first rotation angle with respect to the rotation axis, a positional relationship in which a first illumination light output from a first end point among illumination lights output from the surface light source is specularly reflected by the micro region and is incident on the camera;
calculating, as a second rotation angle with respect to the rotation axis, a positional relationship in which a second illumination light output from a second end point among illumination lights output from the surface light source is specularly reflected by the micro region and is incident on the camera; and
determining that a difference between the calculated first rotation angle and the calculated second rotation angle is the unit rotation angle.

What is claimed is:

1. An information processing method comprising:
by a processor, when determining a unit rotation angle in a case where at least one of a capturing device including a camera and a surface light source and an existing object is rotationally moved around a preset rotation axis and a surface of the object is captured from a plurality of directions,
setting positional coordinates corresponding to the rotation axis, the camera, the surface light source, and a three-dimensional model of the object in a simulation space;
receiving designation of a micro region on the three-dimensional model of the object;
calculating, as a first rotation angle with respect to the rotation axis, a positional relationship in which a first illumination light output from a first end point among illumination lights output from the surface light source is specularly reflected by the micro region and is incident on the camera;
calculating, as a second rotation angle with respect to the rotation axis, a positional relationship in which a second illumination light output from a second end point among illumination lights output from the surface light source is specularly reflected by the micro region and is incident on the camera; and
determining that a difference between the calculated first rotation angle and the calculated second rotation angle is the unit rotation angle.

2. The information processing method according to claim 1, wherein
the first end point is an end portion of the surface light source farther from the camera, and
the second end point is an end portion of the surface light source closer to the camera.

3. The information processing method according to claim 1, further comprising, by the processor, determining the unit rotation angle for a micro region where a distance from the rotation axis to the surface of the object is the longest.

4. The information processing method according to claim 1, further comprising, by the processor, determining the unit rotation angle for a micro region where an angle formed between a half line extending from the rotation axis toward the surface of the object and a normal to the surface of the object is 0°.

5. The information processing method according to claim 1, wherein the surface light source includes a first surface light source and a second surface light source,
the information processing method further comprising arranging the first surface light source and the second surface light source on both sides of a half line connecting the camera and a rotation center.

6. The information processing method according to claim 5, further comprising, by the processor, determining that a smaller one of a first unit rotation angle calculated with respect to the rotation axis for the first surface light source and a second unit rotation angle calculated with respect to the rotation axis for the second surface light source is the unit rotation angle.

7. A non-transitory computer readable medium storing a program causing a computer to execute a process comprising:
when determining a unit rotation angle in a case where at least one of a capturing device including a camera and a surface light source and an existing object is rotationally moved around a preset rotation axis and a surface of the object is captured from a plurality of directions,
setting positional coordinates corresponding to the rotation axis, the camera, the surface light source, and a three-dimensional model of the object in a simulation space;
receiving designation of a micro region on the three-dimensional model of the object;
calculating, as a first rotation angle with respect to the rotation axis, a positional relationship in which a first illumination light output from a first end point among illumination lights output from the surface light source is specularly reflected by the micro region and is incident on the camera;
calculating, as a second rotation angle with respect to the rotation axis, a positional relationship in which a second illumination light output from a second end point among illumination lights output from the surface light source is specularly reflected by the micro region and is incident on the camera; and
determining that a difference between the calculated first rotation angle and the calculated second rotation angle is the unit rotation angle.
